(19) United States
(12) Patent Application Publication
(10) Pub. No.: US 2019/0034118 A1
(43) Pub. Date: Jan. 31, 2019

(54) DATA MANAGEMENT METHOD AND SYSTEM FOR MEMORY DEVICE

(71) Applicant: MACRONIX INTERNATIONAL CO., LTD., Hsinchu (TW)

(72) Inventors: Hung-Sheng Chang, Taipei City (TW); Hsiang-Pang Li, Zhubei City (TW); Yuan-Hao Chang, Taipei City (TW); Tei-Wei Kuo, New Taipei City (TW)

(21) Appl. No.: 15/662,348

(22) Filed: Jul. 28, 2017

(51) Int. Cl. G06F 3/06

(52) U.S. Cl. CPC G06F 3/0659; G06F 3/0679; G06F 3/0619

(57) ABSTRACT

A data management method for a memory device includes: counting a system time; when at least a part of a block of the memory device is accessed or refreshed or programmed at first time, assigning a block number of the block to point to a maximum remaining retention time; when a first downgrade trigger time reaches, assigning the block number to point from the maximum remaining retention time to a medium remaining retention time; when a second downgrade trigger time reaches, assigning the block number to point from the medium remaining retention time to a minimum remaining retention time; and once the block number points to the minimum remaining retention time, refreshing the block and assigning the block number to point to the maximum remaining retention time.

The disclosure relates in general to a data management method and system for a memory device.

### BACKGROUND

As improvement on semiconductor technology, a variety of semiconductor memories are developed. For example, flash memory, magnetic core memory and PCM (phase change memory) may be widely used in electronic devices.

PCM is a non-volatile memory. The material of PCM may be transited between crystalline state and amorphous state, for storing digital data. In reading PCM, resistance of the memory cells of PCM is determined to determine whether the memory cell stores logic 0 or logic 1.

However, resistance of memory cells may be shifted after time elapses, for example, shifting from high resistance state into low resistance state or vice versa. Thus, data reading may be error. In order to prevent error data reading, one of possible implementation is to refresh the memory cells or the memory pages after a time of period, for solving resistance shifting.

The application discloses a data management method and system for a memory device, for managing retention time and refresh time of the memory device.

### SUMMARY

According to one embodiment, provided is a data management system for a memory device. The memory device includes a plurality of blocks. The data management system includes: a processor, coupled to the memory device, the processor having a system time counter for counting a system time; and a retention time memory unit, coupled to the processor, the retention time memory unit including a retention mode parameter storage section, a remaining retention time storage section and a block number storage section. The retention mode parameter storage section stores a first retention mode, the remaining retention time storage section stores a first maximum remaining retention time, a first minimum remaining retention time and a first intermediate remaining retention time corresponding to the first retention mode, the block number storage section at least stores a first block number of a first block of the plurality of blocks of the memory device. When at least a part of the first block of the memory device is accessed or refreshed or programmed at first time or each time when the whole first block of the memory device is accessed or refreshed or programmed, the processor assigns the first block number of the first block to point to the first maximum remaining retention time of the first retention mode. When a first downgrade trigger time of the first maximum remaining retention time reaches and when the first block number of the first block currently points to the first maximum remaining retention time, the processor changes pointing of the first block number of the first block from the first maximum remaining retention time to the first intermediate remaining retention time. When a second downgrade trigger time of the first intermediate remaining retention time reaches and when the first block number of the first block currently points to the first intermediate remaining retention time, the processor changes pointing of the first block number of the first block from the first intermediate remaining retention time to the first minimum remaining retention time. Once the first block number of the first block currently points to the first minimum remaining retention time, the processor triggers the memory device to refresh the first block and changes pointing of the first block number of the first block from the first minimum remaining retention time to the first maximum remaining retention time.

According to another embodiment, provided is a data management method for a memory device. The memory device includes a plurality of blocks. The data management method includes: counting a system time; when at least a part of a first block of the memory device is accessed or refreshed or programmed at first time or each time when the whole first block of the memory device is accessed or refreshed or programmed, assigning a first block number of the first block to point to a first maximum remaining retention time of a first retention mode, the first retention mode including the first maximum remaining retention time, a first minimum remaining retention time and a first intermediate remaining retention time; when a first downgrade trigger time of the first maximum remaining retention time reaches and when the first block number of the first block currently points to the first maximum remaining retention time, changing pointing of the first block number of the first block from the first maximum remaining retention time to the first intermediate remaining retention time; when a second downgrade trigger time of the first intermediate remaining retention time reaches and when the first block number of the first block currently points to the first intermediate remaining retention time, changing pointing of the first block number of the first block from the first intermediate remaining retention time to the first minimum remaining retention time; and once the first block number of the first block currently points to the first minimum remaining retention time, triggering the memory device to refresh the first block and changing pointing of the first block number of the first block from the first minimum remaining retention time to the first maximum remaining retention time.

### BRIEF DESCRIPTION OF THE DRAWINGS

FIG. 1 shows a functional block diagram of a data management system for a memory device according to an embodiment of the application.

FIG. 2 shows a retention time memory unit according to an embodiment of the application.

FIGS. 3A-3H show data management according to an embodiment of the application.

FIG. 4 shows another data management according to another embodiment of the application.

FIG. 5 shows a flow chart of a data management method for a memory device according to an embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

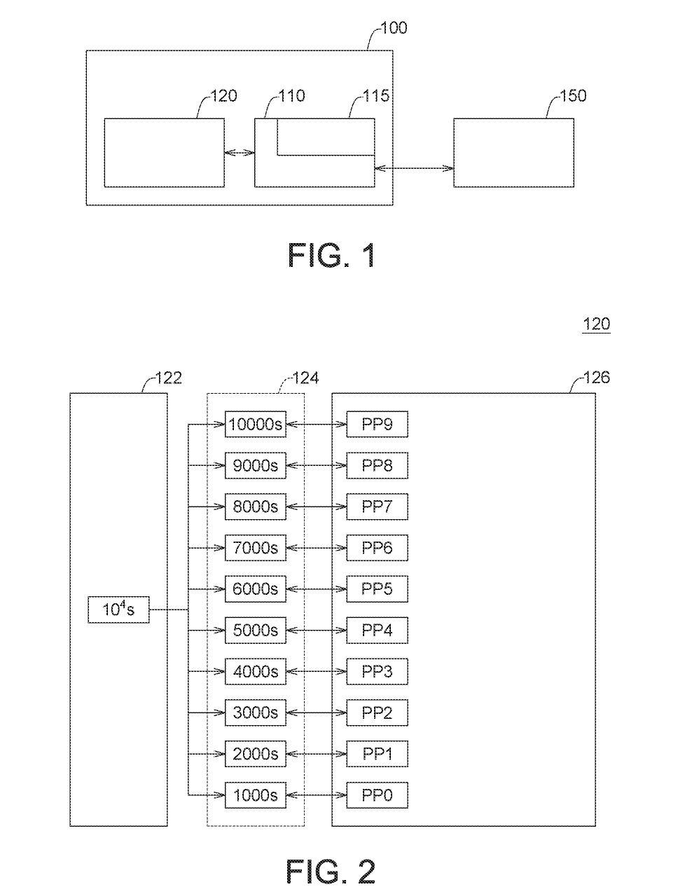

FIG. 1 shows a functional block diagram of a data management system 100 for a memory device according to an embodiment of the application. The data management system 100 is coupled to the memory device 150 for managing data retention of the memory device 150. That is, the data management system 100 decides the respective remaining retention time and the respective refresh time of a plurality of memory pages of the memory device 150.

The data management system 100 includes a processor 110 and a retention time memory unit 120. The processor 110 includes a system time counter 115. The processor 110 is coupled to the memory device 150 and the retention time memory unit 120. The processor 110 manages the remaining retention time and the refresh time of the memory device 150. The operation details of the processor 110 will be described later. The system time counter 115 is for counting system time.

FIG. 2 shows a retention time memory unit according to an embodiment of the application. As shown in FIG. 2, the retention time memory unit 120 includes a retention mode parameter storage section 122, a remaining retention time storage section 124 and a block number storage section 126.

The retention mode parameter storage section 122 is for storing at least one retention mode parameter. The retention mode parameter is for indicating the retention mode of the corresponding blocks. In here, the term “block” refers to the storage blocks of the memory device 150, for example, the memory pages. The memory device 150 includes a plurality of blocks. In the following embodiments, for explanation, all blocks of the memory device 150 is assigned by the same retention mode. However, the application is not limited by this. When a part of a block of the memory device 150 (or even the whole block) is accessed or refreshed or programmed at first time, the processor 110 predicts a default retention time of the block and assigns a retention mode to the block. In the embodiment of the application, when a part of a block of the memory device 150 (or even the whole block) is accessed or refreshed or programmed at first time, this may be the worst case. This is because the corresponding memory cell(s) (which is/are accessed or refreshed or programmed at first time) may reach the retention time earliest. In here, the term “accessed or refreshed or programmed at first time” refers to that after the memory device 150 is manufactured, the block of the memory device 150 is accessed or refreshed or programmed at first time.

In other possible embodiment of the application, each time when the whole block of the memory device 150 is accessed or refreshed or programmed, the CPU 110 predicts a default retention time of the block and assigns a retention mode to the block. Because the whole block is accessed or refreshed or programmed, it is suitable to assign the same retention time to all memory cells of the whole block.

When the retention mode is 10000 seconds, the maximum remaining retention time of the block is 10000 seconds. In other words, in an embodiment of the application, when the block is accessed or refreshed, before the retention time is expired, the embodiment of the application refreshes the block. Similarly, if the retention mode is 10⁷ seconds, when the block is accessed or refreshed, the embodiment of the application refreshes the block before expiration of the retention time (10⁷ seconds).

The remaining retention time storage section 124 indicates the respective remaining retention time of each of the blocks. Taking the retention mode is 10000 seconds as an example, in an embodiment of the application, 10000 seconds is divided into 10 groups, the first group is 10000 seconds, and the second group is 9000 seconds, and so on. Of course, the application is not limited by this. In other possible embodiments of the application, the maximum remaining retention time may be divided into a plurality of groups by other ways. For example, the maximum remaining retention time may be divided into several groups based on log or exponential.

In an embodiment of the application, all blocks of the memory device 150 are grouped based on their remaining retention time and the blocks having the same remaining retention time are in the same group.

For example, at a time point, if the remaining retention time of the block P9 is 10000 second, the processor 110 groups the block number PP9 of the block P9 into the first group; if the remaining retention time of the block P8 is 9000 second, the processor 110 groups the block number PP8 of the block P8 into the second group; and if the remaining retention time of the block P0 is 1000 second, the processor 110 groups the block number PP0 of the block P0 into the tenth group, and so on. “10000-second” is defined as the maximum remaining retention time, “1000-second” is defined as the minimum remaining retention time while “2000-second”-“9000-second” may be defined as the intermediate remaining retention time.

The block number storage section 126 is for storing block number of the blocks of the memory device 150. When a block is refreshed or accessed or programmed, the processor 110 assigns the block number of the block to be pointed to the maximum remaining retention time. When the downgrade trigger condition of the block is met, the processor 110 downgrades the block number of the block which meets the downgrade trigger condition and accordingly, the block number of the block points to the next remaining retention time. In an embodiment of the application, each group has its own downgrade trigger condition.

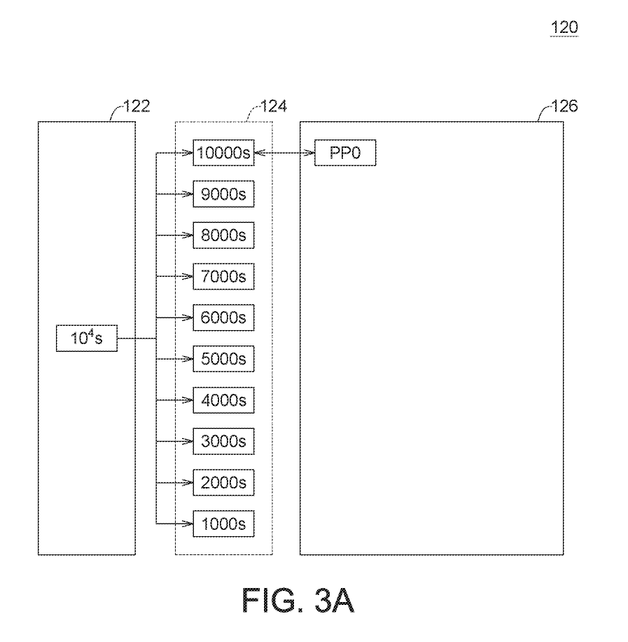

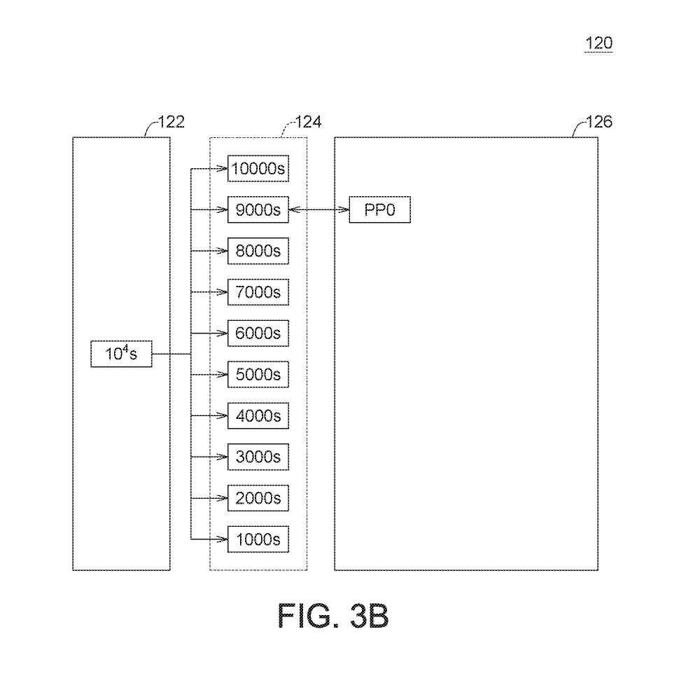

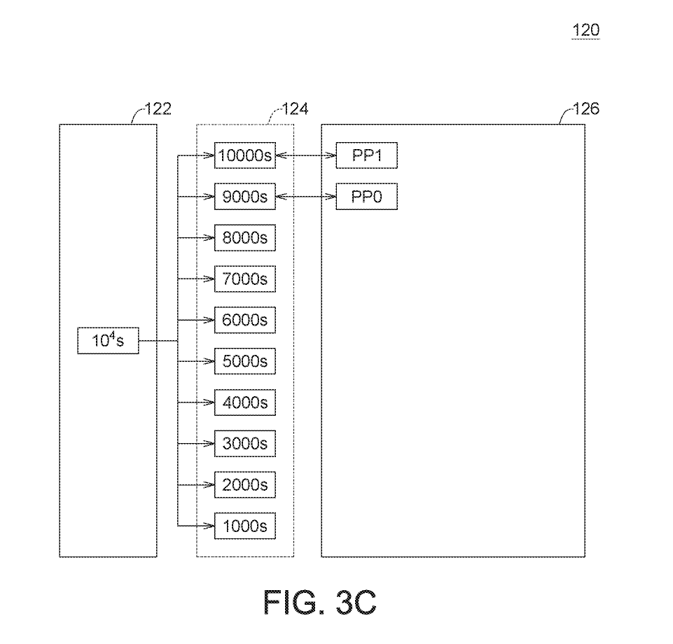

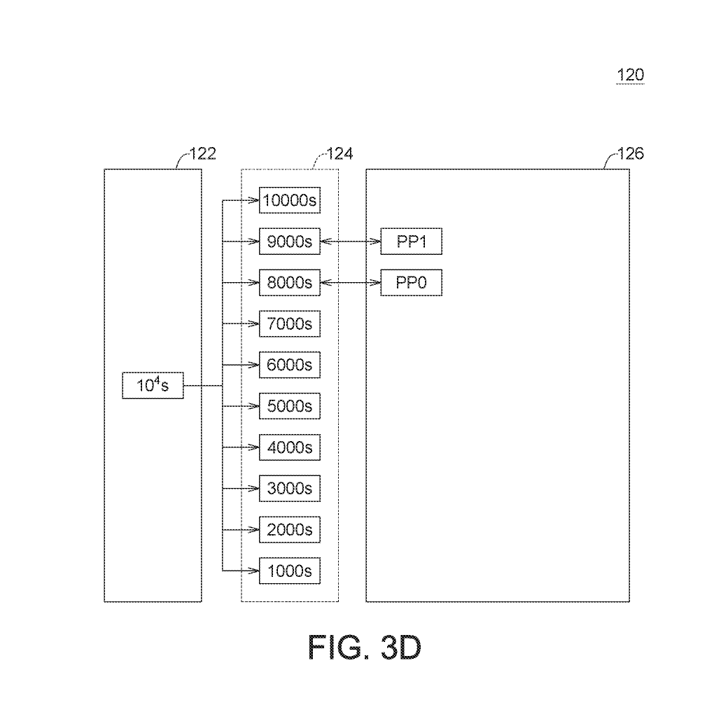

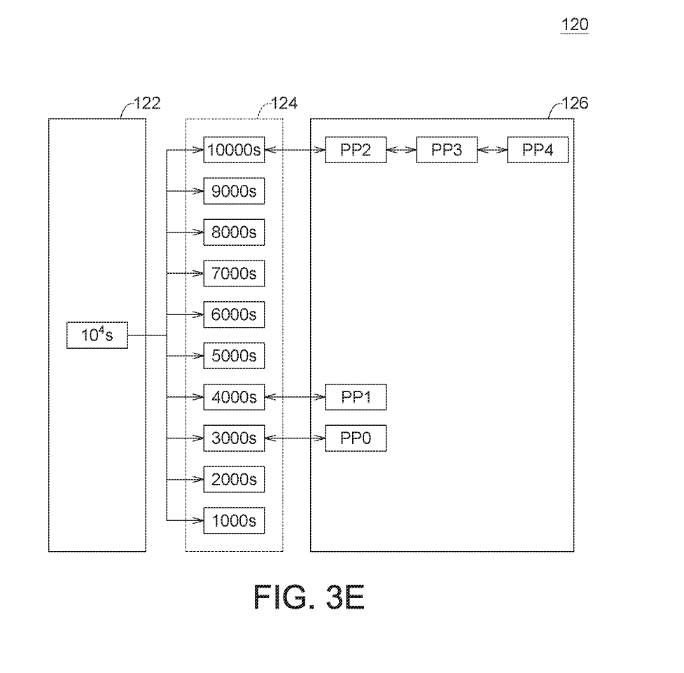

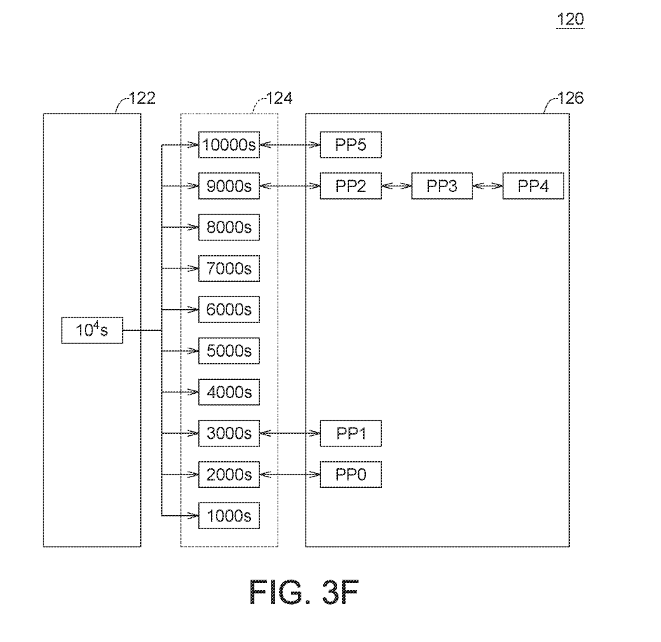

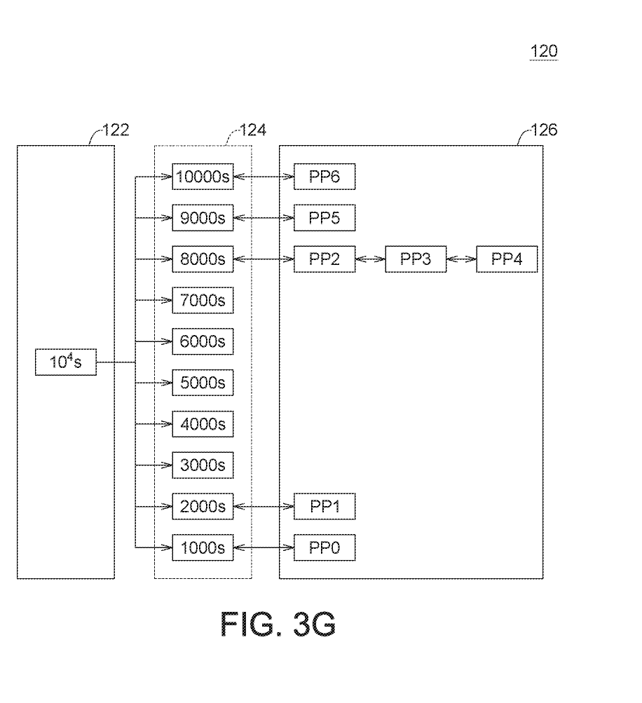

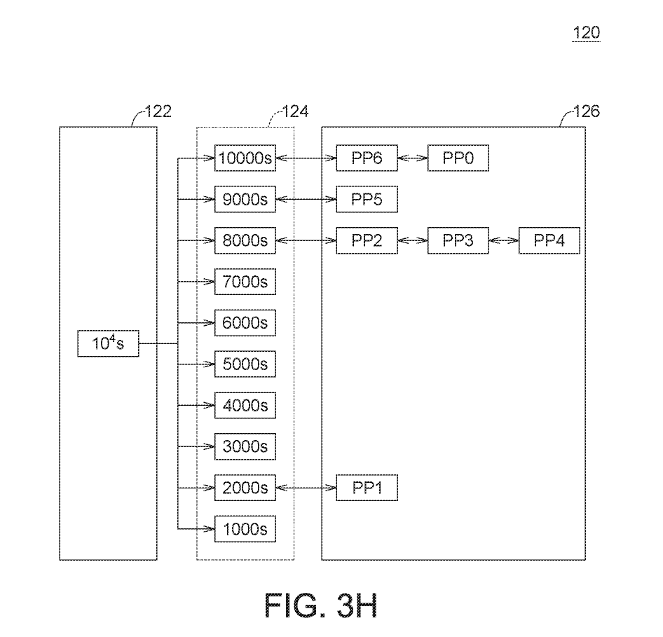

FIGS. 3A-3H show data management according to an embodiment of the application. For explanation, the system time (ST) of the system time counter 115 starts at 0 second (ST=0). In the following, the reference symbols PP0-PP6 in the block number storage section 126 refer to the respective block number of the blocks P0-P6 (the blocks P0-P6, not shown, being in the memory device 150). In practice, the block number may be implemented by pointers which points to the corresponding block of the memory device 150.

As shown in FIG. 3A, when system time is 0 second (ST=0), the block P0 is accessed or refreshed, and the processor 110 assigns the remaining retention time of the block P0 as 10000 seconds. Thus, the processor 110 groups the block number PP0 of the block P0 as the first group and the block number PP0 of the block P0 points to “10000 seconds”, which means that the remaining retention time of the block P0 is 10000 seconds. That is, in an embodiment of the application, before the system time reaches 10000 seconds, the block(s) corresponding to the block number of the first group is/are refreshed to prevent block data error.

In an embodiment of the application, the processor 110 may predict the retention time of the block based on the programming or accessing or refreshing condition(s) (for example but not limited by, the pulse voltages) or the chip temperature of the memory device 150. For example, the processor 110 may predict retention time of a worst case of the memory cells of the same block (i.e. the same memory page) as the retention time of the block. How to predict the retention time is not specified in the embodiment of the application.

Thus, in an embodiment of the application, each block is assigned by a retention mode. The embodiment of the application may have a plurality of retention modes. For simplicity, all blocks are assigned by the same retention mode but the application is not limited by.

As shown in FIG. 3B, when the system time is 1000 seconds (ST=1000), the processor 110 determines to trigger the downgrade on the first group (that is, the downgrade condition of the first group is triggered). The processor 110 downgrades the block number PP0 of the first group as the second group. In here, “downgrade” refers to that the processor 110 changes the block number of the same group from pointing to the current group as pointing to the next group, or said, from pointing to the current remaining retention time to the next remaining retention time. The principle of the downgrade by the processor 110 is that the processor 110 obtains the respective remaining retention time of each group and thus when the system reaches the trigger time, the processor 110 triggers downgrade. Taking the first group as an example. The remaining retention time of the first group is 10000 seconds and the remaining retention time of the second group is 9000 seconds. Thus, the “group remaining retention time gap” of the first group is 10000−9000=1000 (seconds). When the system is at 1000 (s), 2000 (s), . . . , 9000 (s), 10000 (s), 11000 (s), 12000 (s), the processor 110 downgrades the first group (i.e. the first group is downgraded once every 1000 seconds). Similarly, the remaining retention time of the second group is 9000 seconds and the remaining retention time of the third group is 8000 seconds. Thus, when the system is at 2000 (s), 3000 (s), . . . , 9000 (s), 10000 (s), 11000 (s), 12000 (s), the processor 110 downgrades the second group. That is, in the embodiment of the application, when the downgrade condition is triggered, the processor 110 downgrades the block number of the blocks of the same group from the current group to the next group. This means that the processor 110 reduces the remaining retention time of the block(s) whose block number is/are downgraded.

In the above example, the “group remaining retention time gaps” for each of the groups are the same, but in other possible embodiment of the application, the “group remaining retention time gaps” for the groups may be different, which is still within the spirit and scope of the application. For example, in other possible embodiment of the application which having five groups, the remaining retention time of the first group is 10000 seconds, the remaining retention time of the second group is 9000 seconds, the remaining retention time of the third group is 7500 seconds, the remaining retention time of the fourth group is 5500 seconds, and the remaining retention time of the fifth group is 1000 seconds. When to downgrade is based on the difference between the remaining retention time of two groups. In this case, the remaining retention time of the first group and the second group are 10000 seconds and 9000 seconds, respectively, and thus the difference between the remaining retention time of the first group and the second group is 1000 seconds. Thus, the CPU 110 downgrades the first group every 1000 seconds. The CPU 110 downgrades the second group every 1500 seconds. The CPU 110 downgrades the third group every 2000 seconds. The CPU 110 downgrades the fourth group every 4500 seconds.

As shown in FIG. 3C, when the system time is at 1500 seconds (ST=1500), the block P1 is accessed or refreshed. Thus, the processor 110 sets the remaining retention time of the block P1 as 10000 seconds, the processor 110 groups the block number PP1 of the block P1 into the first group (whose remaining retention time is 10000 seconds) and the processor 110 groups the block number PP0 of the block P0 into the second group (whose remaining retention time is 9000 seconds).

As shown in FIG. 3D, when the system time is at 2000 seconds (ST=2000), the processor 110 downgrades the first group and the second group. The processor 110 downgrades the block number PP0 of the block P0 from the second group into the third group (whose remaining retention time is 8000 seconds) and downgrades the block number PP1 of the block P1 from the first group into the second group (whose remaining retention time is 9000 seconds).

Then, when the system time is at 3000 seconds (ST=3000) (not shown), the processor 110 downgrades the second group and the third group. The processor 110 downgrades the block number PP0 of the block P0 from the third group into the fourth group (whose remaining retention time is 7000 seconds) and downgrades the block number PP1 of the block P1 from the second group into the third group (whose remaining retention time is 8000 seconds). Similarly, when the system time is at 7000 seconds (ST=7000) (not shown), the processor 110 performs downgrade. The processor 110 downgrades the block number PP0 of the block P0 from the seventh group into the eighth group (whose remaining retention time is 3000 seconds) and downgrades the block number PP1 of the block P1 from the sixth group into the seventh group (whose remaining retention time is 4000 seconds).

As shown in FIG. 3E, when the system time is at 7950 seconds (ST=7950), the blocks P2-P4 are accessed or refreshed (i.e. all data in the blocks P2-P4 is refreshed). Thus, the processor 110 sets the remaining retention time of the blocks P2-P4 as 10000 seconds, the processor 110 groups the block number PP2-PP4 of the blocks P2-P4 into the first group (whose remaining retention time is 10000 seconds). Meanwhile, the block number PP0 of the block P0 is still within the eighth group and the block number PP1 of the block P1 is still within the seventh group. In an embodiment of the application, access time or refresh time of the blocks P2-P4 may be different. Assume that the block P2 is accessed or refreshed first (but the blocks P3 and P4 are not accessed or refreshed yet). Then, when the block number PP2 of the block P2 is still within the first group, the blocks P3 and P4 are accessed or refreshed. Thus, the processor 110 groups the block number PP2-PP4 of the blocks P2-P4 into the first group.

When the system time is at 8000 seconds (ST=8000) (not shown), the processor 110 downgrades the block number PP0-PP4 of the blocks P0-P4. The processor 110 downgrades the block number PP2-PP4 of the blocks P2-P4 from the first group into the second group (whose remaining retention time is 9000 seconds). The processor 110 downgrades the block number PP0 of the block P0 from the eighth group into the ninth group (whose remaining retention time is 2000 seconds). The processor 110 downgrades the block number PP1 of the block P1 from the seventh group into the eighth group (whose remaining retention time is 3000 seconds).

As shown in FIG. 3F, when the system time is at 8950 seconds (ST=8950), the block P5 is accessed or refreshed. Thus, the processor 110 sets the remaining retention time of the block P5 as 10000 seconds, the processor 110 groups the block number PP5 of the block P5 into the first group (whose remaining retention time is 10000 seconds). Meanwhile, the block number PP0 of the block P0 is still within the ninth group (whose remaining retention time is 2000 seconds), the block number PP1 of the block P1 is still within the eighth group (whose remaining retention time is 3000 seconds) and the block number PP2-PP4 of the blocks P2-P4 is still within the second group (whose remaining retention time is 9000 seconds).

As shown in FIG. 3G, when the system time is at 9000 seconds (ST=9000), the block P6 is accessed or refreshed and the processor 110 downgrades the blocks P0-P5. Thus, the processor 110 sets the remaining retention time of the block P6 as 10000 seconds and the processor 110 groups the block number PP6 of the block P6 into the first group (whose remaining retention time is 10000 seconds). Meanwhile, the processor 110 downgrades the block number PP5 of the block P5 from the first group into the second group (whose remaining retention time is 9000 seconds). The processor 110 downgrades the block number PP2-PP4 of the blocks P2-P4 from the second group into the third group (whose remaining retention time is 8000 seconds). The processor 110 downgrades the block number PP0 of the block P0 from the ninth group into the tenth group (whose remaining retention time is 1000 seconds). The processor 110 downgrades the block number PP1 of the block P1 from the eighth group into the ninth group (whose remaining retention time is 2000 seconds).

In an embodiment of the application, when a block number is downgraded into the lowest group (for example, the tenth group (whose remaining retention time is 1000 seconds) in the above example), the processor 110 upgrades the block number from the lowest-group into the first group and also the processor 110 informs the memory device 150 to refresh the block whose block number is upgraded from the lowest-group into the first group. As shown in FIG. 3H, when the system time is at 9000 seconds (ST=9000), the processor 110 upgrades the block number PP0 of the block P0 from the lowest group into the first group and also, the processor 110 informs the memory device 150 to refresh the block P0. Because the block number PP6 of the block P6 is also in the first group, the processor 110 assigns the block number PP0 of the block P0 to point to the block number PP6 of the block P6 and the block number PP6 of the block P6 is pointed to 10000 seconds.

Further, in an embodiment of the application, because the block number in the same group are pointed to each other, in block refresh, it is easy to determine which block(s) is/are to be refreshed. For example, when the block number PP2-PP4 are in the same group, if the processor 110 downgrades the block number PP2-PP4 into the lowest group, the processor 110 informs the memory device 150 to refresh the blocks P2-P4. In details, because the block number PP2 is pointed to the lowest remaining retention time, the block number PP3 is pointed to the block number PP2, and the block number PP4 is pointed to the block number PP3 (via the point relationship of the block number PP2-PP4), the processor 110 determines that the group having lowest remaining retention time includes the block number PP2-PP4. Thus, the processor 110 determines that the block number PP2-PP4 should be ungraded and the blocks P2-P4 (which is corresponded to the block number PP2-PP4) should be refreshed. In the disclosure, among one or more block number which is/are pointed to the same remaining retention time, one block number (for example but not limited to, the block number PP2 in FIG. 3E) is directly pointed to the remaining retention time and other block number (for example but not limited to, the block number PP3-PP4 in FIG. 3E) is indirectly pointed to the remaining retention time.

In an embodiment of the application, if a block is accessed or refreshed, the processor 110 upgrades the block number of the accessed or refreshed block into the first group (regardless of which group the block number belongs). In other words, if a block is accessed or refreshed, the processor 110 sets the remaining retention time of the block as the maximum remaining retention time (for example 10000 seconds). Further, when the block is accessed or refreshed, the block number of the block is currently pointed to the first group, and then the block number of the block is still in the first group.

Still further, in an embodiment of the application, after downgrade, when there are several block number concurrently pointing to the lowest remaining retention time, the processor 110 sequentially triggers refresh of the blocks, that is, the blocks may be refreshed at different timing. For example, after downgrade, the block number PP0 and PP1 concurrently point to the lowest remaining retention time (1000 seconds). When the system time is at 9000 seconds, the processor 110 informs the memory device 150 to refresh the block P0. When the system time is at 9050 seconds, the processor 110 informs the memory device 150 to refresh the block P1. By so, before the remaining retention time of the blocks P0 and P1 are expired, the blocks P0 and P1 are refreshed, in order to prevent data reading error caused by resistance shift of the blocks P0 and/or P1.

In brief, in an embodiment of the application, when a block is accessed or refreshed, the processor 110 upgrades the block number of the block to the first group to point to the maximum remaining retention time. Besides, the processor 110 determines one or more block number concurrently pointing to the same remaining retention time as the same group. In the same group, one of the block number points to the corresponding remaining retention time and other block number points to each other. For example, in FIG. 3F, among the block number PP2-PP4, the block number PP2 points to the corresponding remaining retention time, the block number PP3 points to the block number PP2, and the block number PP4 points to the block number PP3.

When the processor 110 determines that downgrade trigger condition of a group is met, the processor 110 downgrades all block number of the group into the next group. In practice, under control of the processor 110, pointing of the first block number of the group (for example, the block number PP2 of the second group in FIG. 3F) is changed from the current remaining retention time to the next remaining retention time, while pointing of other block number of the same group (for example, the block number PP3-PP4 of the second group in FIG. 3F) is not changed. Thus, by changing the pointing of the first block number in the group, pointing of the group is changed to the next remaining retention time.

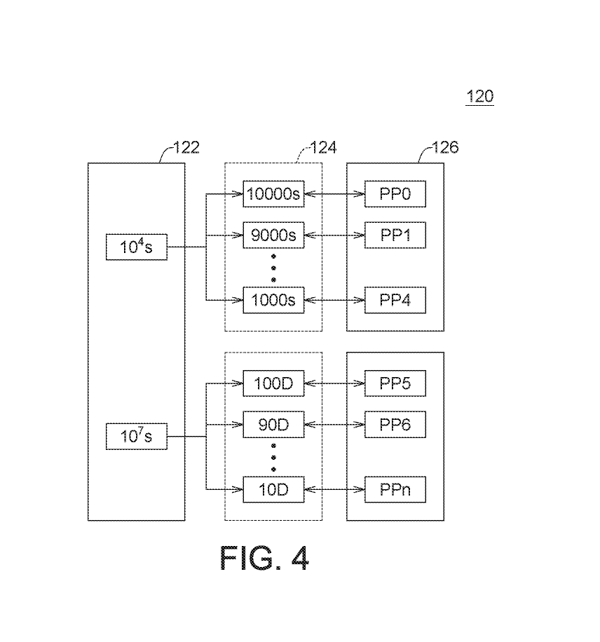

FIG. 4 shows another data management according to another embodiment of the application. As shown in FIG. 4, there are two retention modes, 10⁴ seconds and 10⁷ seconds. The retention modes may have different retention time from each other. For example, the retention mode of 10⁴ seconds includes retention time of 10000 seconds, 9000 seconds, . . . and 1000 seconds (wherein the block number PP0, PP1 and PP4 point to 10000 seconds, 9000 seconds and 1000 seconds). While the retention mode of 10⁷ seconds includes retention time of 100 days (D), 90 days, . . . and 10 days (wherein the block number PP5, PP6 and PPn point to 100 days, 90 days and 10 days). Of course, other possible embodiments of the application may include more retention modes, which is still within the spirit and scope of the application.

In FIG. 4, when the block(s) is/are accessed or programmed or refreshed, the processor 110 may predict the default retention time of the block(s) to determine the retention mode of the block(s). For example, when the block P0 is accessed, the processor 110 predicts the default retention time of the block P0 is 20000 seconds, and thus the processor 110 assigns the retention mode of the block P0 is 10000 (10⁴) seconds. The processor 110 assigns the block number PP0 of the block P0 to point to the maximum remaining retention time (10000 seconds). In another example, when the block P5 is accessed, the processor 110 predicts the default retention time of the block P5 is 150 days, and thus the processor 110 assigns the retention mode of the block P5 is 10⁷ seconds. The processor 110 assigns the block number PP5 of the block P5 to point to the maximum remaining retention time (100 days). That is to say, in an embodiment of the application, each block is corresponding to one retention mode.

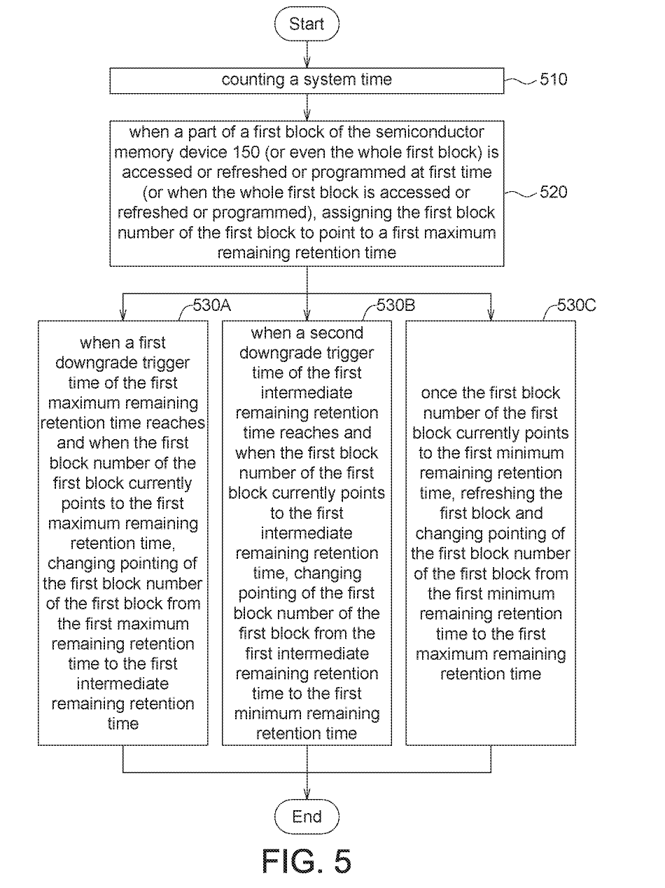

FIG. 5 shows a flow chart of a data management method for a memory device according to an embodiment of the application. As shown in FIG. 5, at step 510, a system time is counted. At step 520, when a part of a first block of the memory device 150 (or even the whole first block) is accessed or refreshed or programmed at first time (or when the whole first block is accessed or refreshed or programmed), the processor 110 assigns the first block number of the first block to point to a first maximum remaining retention time of a first retention mode. The first retention mode include the first maximum remaining retention time, a first minimum remaining retention time and a first intermediate remaining retention time. At step 530A, when a first downgrade trigger time of the first maximum remaining retention time reaches and when the first block number of the first block currently points to the first maximum remaining retention time, the processor 110 changes pointing of the first block number of the first block from the first maximum remaining retention time to the first intermediate remaining retention time. At step 530B, when a second downgrade trigger time of the first intermediate remaining retention time reaches and when the first block number of the first block currently points to the first intermediate remaining retention time, the processor 110 changes pointing of the first block number of the first block from the first intermediate remaining retention time to the first minimum remaining retention time. At step 530C, once the first block number of the first block currently points to the first minimum remaining retention time, the processor 110 triggers the memory device to refresh the first block and changes pointing of the first block number of the first block from the first minimum remaining retention time to the first maximum remaining retention time.

In an embodiment of the application, by managing the remaining retention time of the blocks of the memory device in groups, the blocks may be refreshed before the respective remaining retention time of the blocks is expired. Thus, data reading error caused by resistance shift of the blocks may be prevented. Further, in an embodiment of the application, because the remaining retention time of the blocks is/are managed in groups, the management is simplified.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A data management system for a memory device, the memory device including a plurality of blocks, the data management system including:
a processor, coupled to the memory device, the processor having a system time counter for counting a system time; and
a retention time memory unit, coupled to the processor, the retention time memory unit including a retention mode parameter storage section, a remaining retention time storage section and a block number storage section, the retention mode parameter storage section storing a first retention mode, the remaining retention time storage section storing a first maximum remaining retention time, a first minimum remaining retention time and a first intermediate remaining retention time corresponding to the first retention mode, the block number storage section at least storing a first block number of a first block of the plurality of blocks of the memory device,
wherein
when at least a part of the first block of the memory device is accessed or refreshed or programmed at first time or each time when the whole first block of the memory device is accessed or refreshed or programmed, the processor assigns the first block number of the first block to point to the first maximum remaining retention time of the first retention mode;
when a first downgrade trigger time of the first maximum remaining retention time reaches and when the first block number of the first block currently points to the first maximum remaining retention time, the processor changes pointing of the first block number of the first block from the first maximum remaining retention time to the first intermediate remaining retention time;
when a second downgrade trigger time of the first intermediate remaining retention time reaches and when the first block number of the first block currently points to the first intermediate remaining retention time, the processor changes pointing of the first block number of the first block from the first intermediate remaining retention time to the first minimum remaining retention time; and
once the first block number of the first block currently points to the first minimum remaining retention time, the processor triggers the memory device to refresh the first block and changes pointing of the first block number of the first block from the first minimum remaining retention time to the first maximum remaining retention time.

2. The data management system according to claim 1, wherein when the first block number of the first block currently points to the first maximum remaining retention time, if at least a part of a second first block of the memory device is accessed or refreshed or programmed at first time or each time if the whole second block of the memory device is accessed or refreshed or programmed, the processor assigns a second block number of the second block to point to the first block number of the first block.

3. The data management system according to claim 1, wherein
the retention mode parameter storage section further stores a second retention mode,
when a third block of the memory device is accessed or refreshed or programmed, the processor predicts a remaining retention time of the third block, and assigns the second retention mode to a third block number of the third block based on the predicted remaining retention time of the third block, and the processor assigns the third block number of the third block to point to a second maximum remaining retention time of the second retention mode.

4. The data management system according to claim 1, wherein when the first block number of the first block and a fourth block number of a fourth block concurrently point to the first minimum remaining retention time, the processor triggers the memory device to refresh the first block and the fourth block at different timing.

5. A data management method for a memory device, the memory device including a plurality of blocks, the data management method including:
counting a system time;
when at least a part of a first block of the memory device is accessed or refreshed or programmed at first time or each time when the whole first block of the memory device is accessed or refreshed or programmed, assigning a first block number of the first block to point to a first maximum remaining retention time of a first retention mode, the first retention mode including the first maximum remaining retention time, a first minimum remaining retention time and a first intermediate remaining retention time;
when a first downgrade trigger time of the first maximum remaining retention time reaches and when the first block number of the first block currently points to the first maximum remaining retention time, changing pointing of the first block number of the first block from the first maximum remaining retention time to the first intermediate remaining retention time;
when a second downgrade trigger time of the first intermediate remaining retention time reaches and when the first block number of the first block currently points to the first intermediate remaining retention time, changing pointing of the first block number of the first block from the first intermediate remaining retention time to the first minimum remaining retention time; and
once the first block number of the first block currently points to the first minimum remaining retention time, triggering the memory device to refresh the first block and changing pointing of the first block number of the first block from the first minimum remaining retention time to the first maximum remaining retention time.

6. The data management method according to claim 5, further including:
when the first block number of the first block currently points to the first maximum remaining retention time, if at least a part of a second first block of the memory device is accessed or refreshed or programmed at first time or each time if the whole second block of the memory device is accessed or refreshed or programmed, assigning a second block number of the second block to point to the first block number of the first block.

7. The data management method according to claim 5, further including:
when a third block of the memory device is accessed or refreshed or programmed, predicting a remaining retention time of the third block, assigning the second retention mode to a third block number of the third block based on the predicted remaining retention time of the third block, and assigning the third block number of the third block to point to a second maximum remaining retention time of the second retention mode which is different from the first retention mode.

8. The data management method according to claim 5, further including:
when the first block number of the first block and a fourth block number of a fourth block concurrently point to the first minimum remaining retention time, triggering the memory device to refresh the first block and the fourth block at different timing.
